(19) United States
(12) Patent Application Publication
(10) Pub. No.: US 2026/0171706 A1
(43) Pub. Date: Jun. 18, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yunosuke YAMASAKI, Mie (JP); Tetsuya MIYAMURA, Mie (JP); Akiko SUZUKI, Mie (JP)

(21) Appl. No.: 19/126,645

(22) PCT Filed: Oct. 19, 2023
(86) PCT No.: PCT/JP2023/037912

§ 371 Date: May 2, 2025

(30) Foreign Application Priority Data
Nov. 7, 2022 (JP) 2022-177890

(51) Int. Cl. H01R 13/424

(52) U.S. Cl. CPC H01R 13/424

(57) ABSTRACT

A connector for holding a first terminal and a second terminal includes a base component including a first setting recess, in which the first terminal is set, an inner component to be overlaid on the base component to close an opening on a side opposite to a bottom of the first setting recess and including a second setting recess, in which the second terminal is set, and a cover component to be overlaid on the inner component to close an opening on a side opposite to a bottom of the second setting recess. The cover component is united in contact with the base component with the inner component sandwiched between the base component and the cover component.

### TECHNICAL FIELD

The present disclosure relates to a connector.

### BACKGROUND

Patent Document 1 discloses a dielectric configured by uniting a holding member and a cover member in a direction intersecting an axial direction of a wire, and capable of accommodating an inner conductor. The cover member is formed with a guiding portion. The guiding portion brings the holding member and the cover member closer in a uniting direction in the process of displacing the cover member in a front-rear direction from a temporary assembly position to a proper assembly position when the cover member and the holding member are united. In this way, the rattling of the cover member and the holding member in the uniting direction is suppressed.

### PRIOR ART DOCUMENT

### Patent Document

Patent Document 1: JP 2018-147558 A

### SUMMARY OF THE INVENTION

### Problems to be Solved

It is assumed that a plurality of terminals are accommodated separately in upper and lower stages in a connector and the positions of the terminals in the upper and lower stages are restricted by separate upper and lower cover members.

In this case, the accumulation of dimensional tolerances of a plurality of components possibly affects position errors of the upper and lower cover members. If the position errors of the upper and lower cover members become larger, relative position deviations between the terminals in the upper and lower stages possibly increase.

Accordingly, the present disclosure aims to reduce relative position deviations between different terminals.

### Means to Solve the Problem

The present disclosure is directed to a connector for holding a first terminal and a second terminal, the connector being provided with a base component including a first setting recess, the first terminal being set in the first setting recess, an inner component to be overlaid on the base component to close an opening on a side opposite to a bottom of the first setting recess, the inner component including a second setting recess, the second terminal being set in the second setting recess, and a cover component to be overlaid on the inner component to close an opening on a side opposite to a bottom of the second setting recess, the cover component being united in contact with the base component with the inner component sandwiched between the base component and the cover component.

### Effect of the Invention

According to the present disclosure, relative position deviations between different terminals can be reduced.

### BRIEF DESCRIPTION OF THE DRAWINGS

FIG. 1 is a perspective view showing a connector unit according to an embodiment.

FIG. 2 is a perspective view showing the connector.

FIG. 3 is an exploded perspective view showing the connector.

FIG. 4 is an exploded perspective view showing the connector.

FIG. 5 is a section along V-V of FIG. 1.

FIG. 6 is a section along VI-VI of FIG. 1.

FIG. 7 is a diagram showing an assembly operation example of the connector.

FIG. 8 is a diagram showing the assembly operation example of the connector.

### DETAILED DESCRIPTION TO EXECUTE THE INVENTION

### Description of Embodiments of Present Disclosure

First, embodiments of the present disclosure are listed and described.

The connector of the present disclosure is as follows.

(1) The connector of the present disclosure for holding a first terminal and a second terminal is provided with a base component including a first setting recess, the first terminal being set in the first setting recess, an inner component to be overlaid on the base component to close an opening on a side opposite to a bottom of the first setting recess, the inner component including a second setting recess, the second terminal being set in the second setting recess, and a cover component to be overlaid on the inner component to close an opening on a side opposite to a bottom of the second setting recess, the cover component being united in contact with the base component with the inner component sandwiched between the base component and the cover component.

According to the present disclosure, the cover component is united in contact with the base component with the inner component sandwiched between the base component and the cover component. Thus, the first terminal in the first setting recess is positioned between the base component and the inner component positioned on the basis of the base component. The second terminal in the second setting recess is positioned between the inner component positioned on the basis of the base component and the cover component. Thus, the accumulation of dimensional tolerances of a plurality of the components hardly affects a relative positional relationship of the first and second terminals. Therefore, relative position deviations between the different terminals can be reduced.

(2) In the connector of (1), the base component and the cover component may surround the inner component.

In this case, errors of the outer shape of the connector can be reduced as compared to the case where the outer shape of the connector is defined by a combination of three or more components.

(3) In the connector of (1) or (2), the base component may include a front wall having insertion guide holes for guiding mating terminals to be connected to the first terminal and the second terminal.

In this case, the mating terminals can be smoothly connected to the first and second terminals by positioning the first and second terminals on the basis of the base component having the insertion guide holes.

(4) In the connector of any one of (1) to (3), the base component, the inner component or the cover component may include a crush rib projecting in a uniting direction of the base component, the inner component or the cover component, the crush rib being crushable in a united state of the base component, the inner component and the cover component.

In this case, the crush rib is crushed in the united state of the base component, the inner component and the cover component, whereby rattling between the respective components can be suppressed.

(5) In the connector of (4), the base component or the cover component may include a first crush rib located in a contact part of the base component and the cover component as the crush rib, and the inner component or the cover component may include a second crush rib located in a contact part of the inner component and the cover component as the crush rib.

In this way, the first crush rib is crushed between the base component and the cover component, whereby rattling between the base component and the cover component can be suppressed. Further, the second crush rib is crushed between the inner component and the cover component, whereby rattling between the inner component and the cover component can be suppressed. As a result, the rattling of the entire connector can be suppressed. Since it is not necessary to interpose a crush rib between the base component and the inner component, relative position errors of the base component and the inner component can be reduced. As a result, position errors of the first terminal in the first setting recess of the base component and the second terminal in the second setting recess of the inner component can be reduced.

(6) In the connector of (4) or (5), the crush rib may be shaped to become gradually narrower from a base end side toward a tip side.

In this way, the crush rib can be gradually crushed from the tip according to a gap between the respective components.

(7) In the connector of any one of (4) to (6), the base component, the inner component or the cover component may include a front wall having insertion guide holes for guiding mating terminals to be connected to the first terminal and the second terminal, and the crush rib may be located closer to an edge on side of the front wall than to an edge distant from the front wall in the base component, the inner component or the cover component.

In this way, the rattling of the respective components can be suppressed near the insertion guide holes. In this way, the terminals are more precisely positioned near the insertion guide holes and the mating terminals are easily smoothly connected.

(8) In the connector of any one of (1) to (7), the cover component may include a cover body for closing the opening on the side opposite to the bottom of the second setting recess and a pair of locking walls extending from both sides of the cover body toward both sides of the base component through both outer sides of the inner component and to be locked to the both sides of the base component.

In this way, a configuration for uniting the cover component with the base component can be realized with the inner component sandwiched between the base component and the cover component by locking the pair of locking walls to the both sides of the base component.

(9) In the connector of (8), sliding protrusions may be formed on inner surfaces of the pair of locking walls, and uniting guide grooves for guiding the sliding protrusions along an extension direction of the first terminal may be formed on the both sides of the base component.

In this way, the connector is assembled by uniting the cover component with the base component to move the sliding protrusions along the uniting guide grooves with the inner component overlaid on the base component.

(10) In the connector of (9), the base component may be formed with an interference surface extending in a direction intersecting an extension direction of the uniting guide groove, the interference surface interfering with the sliding protrusion moving with the inner component or the cover component lifted with respect to the base component.

In this way, an assembly error is suppressed.

(11) In the connector of (9) or (10), the base component or the uniting guide groove may have a guide surface for guiding the cover component in a direction to be brought closer to the base component as the sliding protrusion moves along the extension direction of the uniting guide groove.

In this case, if the sliding protrusions are moved along the guide grooves, the cover component approaches the base component and rattling between the cover component and the base component is suppressed.

(12) In the connector of any one of (1) to (11), a first retainer for retaining the first terminal may be formed on the bottom of the first setting recess, and a second retainer for retaining the second terminal may be formed on the bottom of the second setting recess.

In this way, the first and second terminals can be retained from the bottoms of the respective first and second setting recesses. In this way, the posture of the first terminal in the first setting recess and that of the second terminal in the second setting recess are easily aligned.

### Details of Embodiment of Present Disclosure

A specific example of a connector of the present disclosure is described below with reference to the drawings. Note that the present invention is not limited to these illustrations, but is represented by claims and intended to include all changes in the scope of claims and in the meaning and scope of equivalents.

### Embodiment

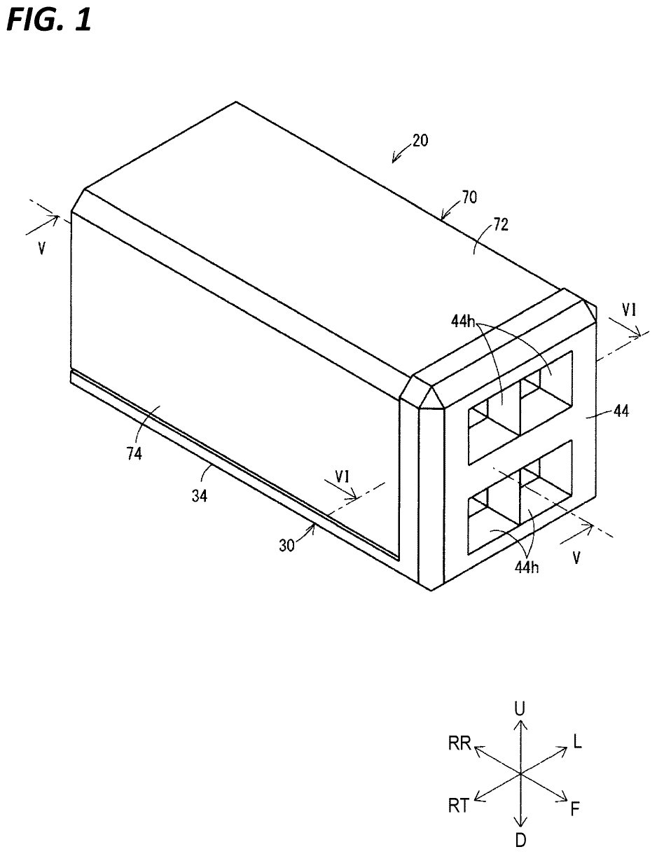

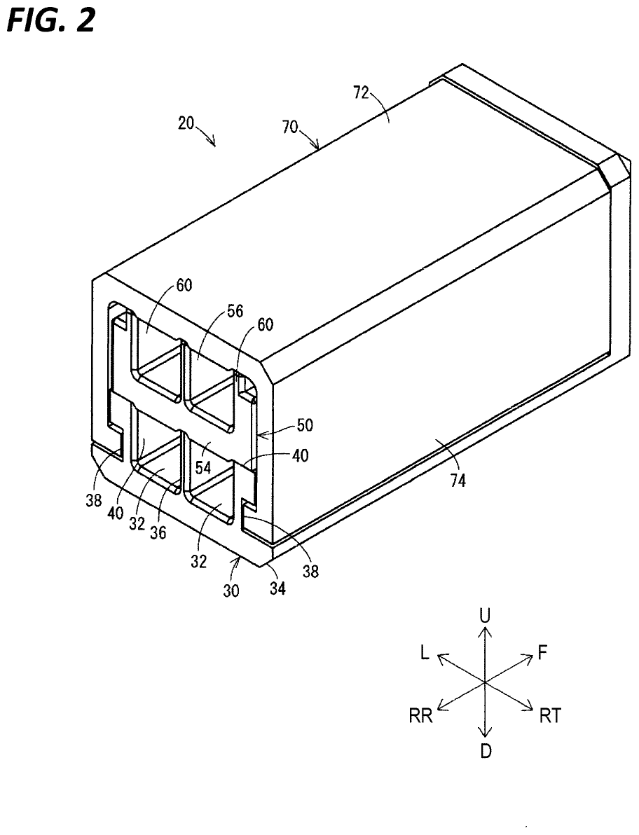

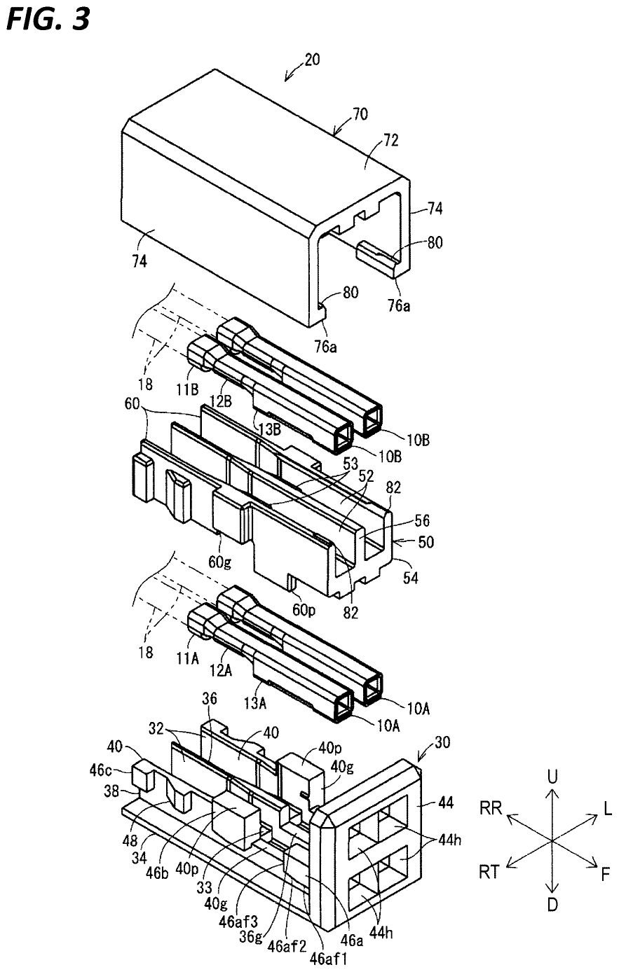

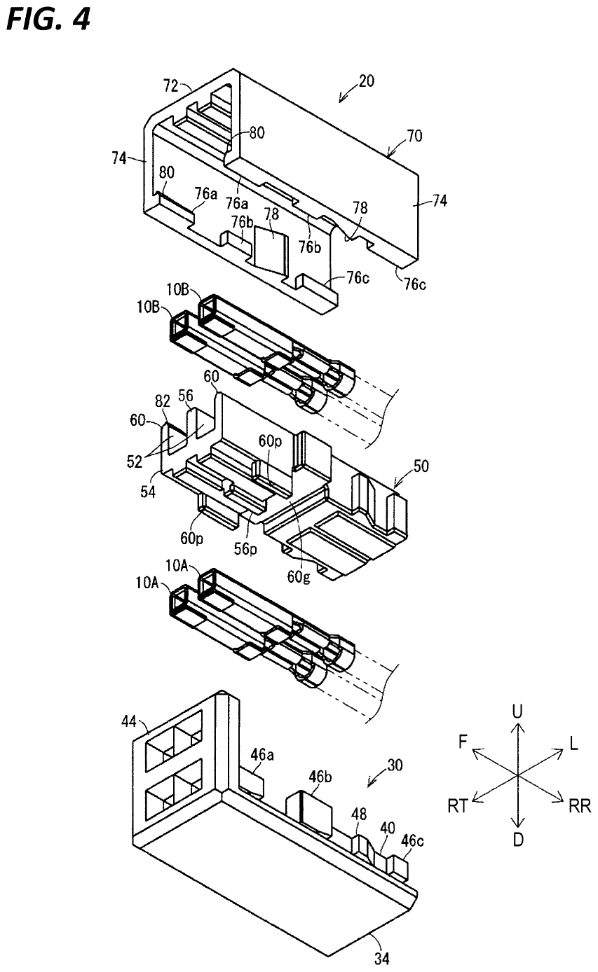

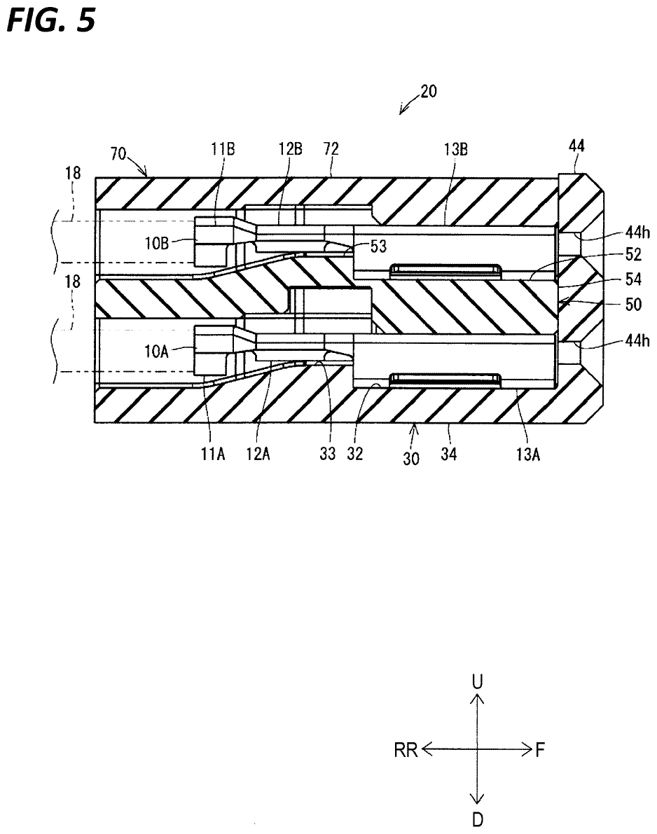

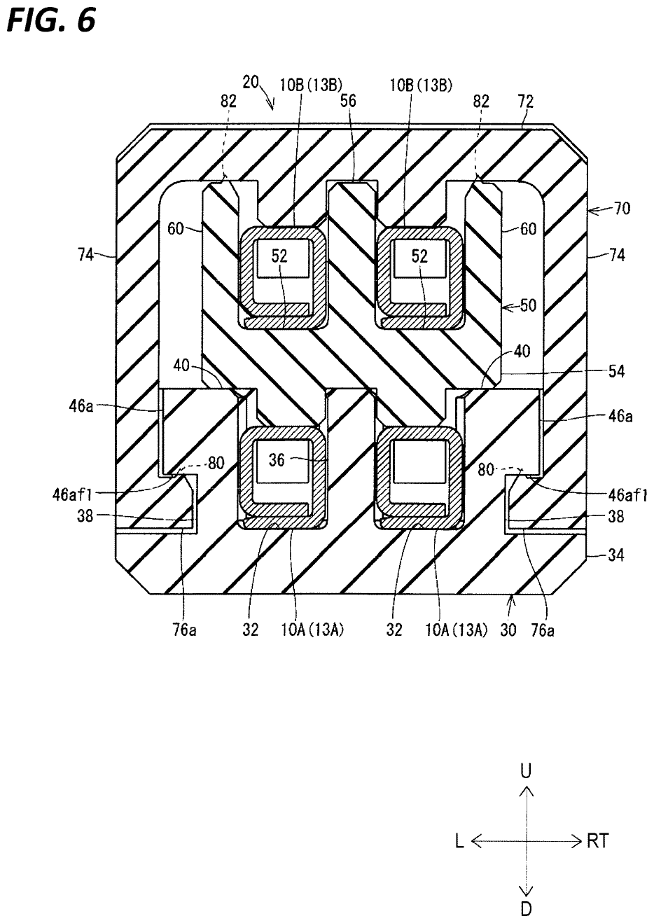

Hereinafter, a connector according to an embodiment is described. FIGS. 1 and 2 are perspective views showing a connector 20. FIGS. 3 and 4 are exploded perspective views showing the connector 20. FIG. 5 is a section along V-V of FIG. 1. FIG. 6 is a section along VI-VI of FIG. 1. In FIGS. 3 to 6, first terminals 10A and second terminals 10B are shown. In FIGS. 3 to 5, wires 18 are shown by two-dot chain lines.

### Overall Structure of Connector

An overall structure of the connector 20 is described. The connector 20 holds the first and second terminals 10A, 10B.

The first and second terminals 10A, 10B are formed, such as by press-working a metal plate. The first terminal 10A includes a coating crimping portion 11A, a core wire crimping portion 12A and a terminal connecting portion 13A. The coating crimping portion 11A is a part to be crimped to a coating in an end part of the wire 18. The core wire crimping portion 12A is a part to be crimped to a core wire exposed in the end part of the wire 18. The terminal connecting portion 13A is a part to be connected to a mating terminal and, for example, formed into a tubular shape. The coating crimping portion 11A, the core wire crimping portion 12A and the terminal connecting portion 13A are linearly arranged in this order. The coating crimping portion 11A and the terminal connecting portion 13A are thicker than the core wire crimping portion 12A. Thus, if the first terminal 10A is observed from a lateral side, a recess is observed above the core wire crimping portion 12A and between the coating crimping portion 11A and the terminal connecting portion 13A.

The second terminal 10B is also provided with a coating crimping portion 11B, a core wire crimping portion 12B and a terminal connecting portion 13B, similarly to the first terminal 10A.

Note that the first and second terminals 10A, 10B may be terminals of the same size, the same material and the like or may be terminals of different sizes, different materials and the like.

In this embodiment, the connector 20 is provided with a plurality of (here, two) first terminals 10A and a plurality of (here, two) second terminals 10B. The plurality of first terminals 10A are arranged in parallel in a row. The plurality of second terminals 10B are also arranged in parallel in a row. The plurality of first terminals 10A and the plurality of second terminals 10B are adjacent to each other. That is, the connector 20 holds the plurality of first terminals 10A and the plurality of second terminals 10B separately in a first stage and a second stage. Note that the numbers of the first terminals 10A and the second terminals 10B held by the connector 20 are arbitrary.

In the following description, the side of the terminal connecting portion 13A and the side of the coating crimping portion 11A may be referred to as a front side and a rear side in an extension direction of the first terminal 10A. Further, the side of the first terminals 10A and the side of the second terminals 10B may be referred to as a lower side and an upper side. Furthermore, a lateral direction may be referred to, assuming a state facing forward standing on the first terminal 10A.

The connector 20 is provided with a base component 30, an inner component 50 and a cover component 70. Each of the base component 30, the inner component 50 and the cover component 70 is a molded product formed from resin or the like.

The base component 30 includes first setting recesses 32, in which the first terminals 10A are set. The first setting recess 32 is a recess closed on lower, left and right sides. By accommodating the first terminal 10A into the first setting recess 32, the first terminal 10A is supported from below and positioned in the lateral direction. A front side of the first setting recess 32 is open. The mating terminal enters the first setting recess 32 from front and is connected to the first terminal 10A. A rear side of the first setting recess 32 is open, and the wire 18 connected to the first terminal 10A is pulled out to the outside of the connector 20 through this rear opening. An upper side of the first setting recess 32 is open, and the first terminal 10A is set into the first setting recess 32 through this upper opening.

The inner component 50 is overlaid on the base component 30 to close the upper openings on a side opposite to the bottoms of the first setting recesses 32. By overlaying the inner component 50 on the base component 30, the first terminals 10A are held in the first setting recesses 32.

Further, the inner component 50 includes second setting recesses 52, in which the second terminals 10B are set. The second setting recess 52 is a recess closed on lower, left and right sides and open on front, rear and upper sides, similarly to the first setting recess 32. The second terminals 10B are accommodated into the second setting recesses 52 in the same manner as the first terminals 10A are accommodated into the first setting recesses 32.

The cover component 70 is overlaid on the inner component 50 to close the upper openings on a side opposite to the bottoms of the second setting recesses 52. By overlaying the cover component 70 on the inner component 50, the second terminals 10B are held in the second setting recesses 52.

With the cover component 70 overlaid on the inner component 50, the inner component 50 is sandwiched between the base component 30 and the cover component 70. In this state, the cover component 70 is united in contact with the base component 30. In this way, the base component 30, the inner component 50 and the cover component 70 are assembled as one connector 20.

Note that the uniting of the cover component 70 in contact with the base component 30 means a state where the cover component 70 and the base component 30 are directly in contact and can be handled as one object. In this embodiment, by engaging the cover component 70 with the base component 30, the inner component 50 between the cover component 70 and the base component 30 can also be handled integrally with the cover component 70 and the base component 30.

As described above, with the base component 30, the inner component 50 and the cover component 70 assembled, the base component 30, the inner component 50 and the cover component 70 are in contact with each other. For example, the base component 30 is in contact with both the inner component 50 and the cover component 70. Thus, a variation of a relative positional relationship of the three components 30, 50 and 70 is easily reduced.

Each component is more specifically described.

### Base Component

The base component 30 is provided with a bottom plate portion 34, an intermediate wall 36 and a pair of outer walls 40.

The bottom plate portion 34 is in the form of a rectangular plate. A lateral width of the bottom plate portion 34 is equal to or larger than a width of the plurality of first terminals 10A arranged in parallel, and a front-rear length of the bottom plate portion 34 is equal to or longer than a length of the first terminal 10A.

The intermediate wall 36 stands in a widthwise intermediate part of the bottom plate portion 34. The intermediate wall 36 is in the form of a rectangular plate along a front-rear direction and a vertical direction. If the base component 30 holds three or more first terminals 10A, a plurality of intermediate walls may stand on a bottom plate portion.

The pair of outer walls 40 stand at positions separated in the lateral direction from the intermediate wall 36 on the upper surface of the bottom plate portion 34. The outer wall 40 is in the form of a rectangular plate along the front-rear direction and the vertical direction. A gap equal to or larger than a width of the first terminal 10A is formed between the intermediate wall 36 and the outer wall 40. The first setting recess 32 is a recess defined by the upper surface of the bottom plate portion 34, either one of the side surfaces of the intermediate wall 36 and the inner surface of either one of the outer walls 40.

A first retainer 33 partially projecting in the front-rear direction is formed on the bottom of the first setting recess 32. The first retainer 33 is a protrusion formed in an intermediate part of the bottom plate portion 34 in the front-rear direction between the intermediate wall 36 and the outer wall 40.

The first terminal 10A is set in the first setting recess 32 with the recess between the coating crimping portion 11A and the terminal connecting portion 13A facing the bottom of the first setting recess 32. Then, the first retainer 33 is fit into the recess between the coating crimping portion 11A and the terminal connecting portion 13A. In this way, the first retainer 33 positions the first terminal 10A in a longitudinal direction of the first terminal 10A and retains the first terminal 10A.

Positioning recesses 36g, 40G partially recessed downward are formed in the upper edges of the intermediate wall 36 and the pair of outer walls 40. By fitting positioning protrusions 56p, 60p of the inner component 50 into the positioning recesses 36g, 40g, the inner component 50 is positioned with respect to the base component 30 in the front-rear direction.

Positioning protrusions 40p partially projecting upward are formed on the upper edges of the intermediate wall 36 and the pair of outer walls 40. By fitting the positioning protrusions 40p into a positioning recess 60g of the inner component 50, the inner component 50 is positioned with respect to the base component 30 in the front-rear direction.

Even if either the positioning recesses 36g, 40g or the positioning protrusions 40p are omitted, the inner component 50 is positioned with respect to the base component 30 in the front-rear direction.

Although both sides of the bottom plate portion 34 project further outward than the pair of outer walls 40 in this embodiment, this is not essential. A pair of outer walls may project from both outer side edges of a bottom plate portion.

Uniting guide grooves 38 used to unite the base component 30 with the cover component 70 are formed in outward facing parts of the pair of outer walls 40. The uniting guide grooves 38 are described later together with a configuration for uniting the base component 30 with the cover component 70.

Further, the base component 30 includes a front wall 44 having insertion guide holes 44h. The front wall 44 is in the form of a rectangular plate and projects from the front edge of the bottom plate portion 34. The front wall 44 extends in a direction orthogonal to an extension direction of the terminals 10A, 10B. The front wall 44 is located in front of the first setting recesses 32 of the base component 30 and in front of the second setting recesses 52 of the inner component 50. The insertion guide holes 44h are formed on forward extensions of the first setting recesses 32 and forward extensions of the second setting recesses 52 in the front wall 44. The insertion guide hole 44h may have a guide surface gradually expanding toward the front, i.e. an outer side.

The mating terminals to be connected to the terminals 10A, 10B are passed through the insertion guide holes 44h and connected to the terminals 10A, 10B in the first setting recesses 32 and the second setting recesses 52. Since functioning to guide the mating terminals toward the terminals 10A, 10B, the insertion guide holes 44h are preferably arranged at fixed positions as much as possible with respect to the terminals 10A, 10B. Here, in a direction orthogonal to the terminals 10A, 10B, the terminals 10A are positioned between the base component 30 and the inner component 50 and the terminals 10B are positioned between the inner component 50 and the cover component 70. Thus, if both the inner component 50 and the cover component 70 are positioned on the basis of the base component 30, the terminals 10A, 10B are easily positioned at the fixed positions with respect to the insertion guide holes 44h.

### Inner Component

The inner component 50 is provided with a bottom plate portion 54, an intermediate wall 56 and a pair of outer walls 60.

The bottom plate portion 54 is in the form of a rectangular plate. A lateral width of the bottom plate portion 54 is equal to or larger than a width of the plurality of first terminals 10A arranged in parallel, and a front-rear length of the bottom plate portion 54 is equal to or longer than a length of the second terminal 10B. Here, the lateral width of the bottom plate portion 54 is smaller than that of the bottom plate portion 54 and the front-rear length of the bottom plate portion 54 is equal to that of the bottom plate portion 34.

The intermediate wall 56 stands in a widthwise intermediate part of the bottom plate portion 54. The intermediate wall 56 is in the form of a rectangular plate along the front-rear direction and the vertical direction. If the base component 30 holds three or more second terminals 10B, a plurality of intermediate walls may stand on a bottom plate portion.

The pair of outer walls 60 stand at positions separated in the lateral direction from the intermediate wall 56 on the upper surface of the bottom plate portion 54. The outer wall 60 is in the form of a rectangular plate along the front-rear direction and the vertical direction. A gap equal to or larger than a width of the second terminal 10B is formed between the intermediate wall 56 and the outer wall 60. The second setting recess 52 is a recess defined by the upper surface of the bottom plate portion 54, either one of the side surfaces of the intermediate wall 56 and the inner surface of either one of the outer walls 60.

A second retainer 53 partially projecting in the front-rear direction is formed on the bottom of the second setting recess 52. The second retainer 53 is a protrusion formed in an intermediate part of the bottom plate portion 54 in the front-rear direction between the intermediate wall 56 and the outer wall 60.

The second terminal 10B is set in the second setting recess 52 with the recess between the coating crimping portion 11B and the terminal connecting portion 13B facing the bottom of the second setting recess 52. Then, the second retainer 53 is fit into the recess between the coating crimping portion 11B and the terminal connecting portion 13B. In this way, the second retainer 53 positions the second terminal 10B in a longitudinal direction of the second terminal 10B and retains the second terminal 10B.

Positioning protrusions 56p, 60p partially projecting downward are formed on downward extensions of the intermediate wall 56 and the pair of outer walls 60 on the bottom surface of the bottom plate portion 54 (see FIG. 4). By fitting the positioning protrusions 56p, 60p into the positioning recesses 36g, 40g of the base component 30, the inner component 50 is positioned with respect to the base component 30 in the front-rear direction.

The positioning recess 60g partially recessed is formed in a part of the bottom plate portion 54 in a longitudinal direction. By fitting the positioning protrusions 40p of the base component 30 into this positioning recess 60g, the inner component 50 is positioned with respect to the base component 30 in the front-rear direction.

Even if either the positioning protrusions 56p, 60p or the positioning recess 60g is/are omitted, the inner component 50 is positioned with respect to the base component 50 in the front-rear direction.

With the first terminals 10A set in the first setting recesses 32, the inner component 50 is overlaid on the base component 30. In this state, the bottom surface of the bottom plate portion 54 of the inner component 50 is in contact with the upper ends of the intermediate wall 36 and the pair of outer walls 40 of the base component 30, whereby a minimum distance of the intermediate wall 36 with respect to the base component 30 in the vertical direction is restricted.

As described later, the inner component 50 is held pressed against the base component 30 by the cover component 70. Thus, the lower surface of the bottom plate portion 54 is in contact with the upper surfaces of the first terminals 10A to restrict upward movements of the first terminals 10A. In this embodiment, the position of the first terminal 10A in the vertical direction is restricted by the terminal connecting portion 13A of the first terminal 10A being sandwiched between the bottom surface of the first setting recess 32 and the downward facing surface of the bottom plate portion 54. Here, elongated protrusions are formed in parts of the bottom plate portion 54 corresponding to forward regions of the first setting recesses 32, and are arranged in the first setting recesses 32 to restrict upward movements of the first terminals 10A. Since upward movements of the first terminals 10A are restricted, the first retainers 33 are held in a state fit in the recesses of the first terminals 10A and, hence, movements of the first terminals 10A in the front-rear direction are restricted. Further, the first terminal 10A is located between both side surfaces of the first setting recess 32 and the position thereof in the lateral direction is restricted. Thus, the first terminals 10A are held at the fixed positions in the first setting recesses 32 by holding the inner component 50 in the state pressed against the base component 30.

### Cover Component

The cover component 70 is a part to be overlaid on the inner component 50 to close openings on a side opposite to the bottoms of the second setting recesses 52. Further, the cover component 70 is united in contact with the base component 30. The cover component 70 and the base component 30 are preferably pressed into contact with each other in the vertical direction.

More specifically, the cover component 70 includes a cover body 72 and a pair of locking walls 74.

The cover body 72 is in the form of a rectangular plate. A lateral width of the cover body 72 is equal to or larger than a width of the plurality of second setting recesses 52 arranged in parallel, and a front-rear length of the bottom plate portion 54 is equal to or longer than the length of the second terminal 10A. With the cover component 70 overlaid on the inner component 50, the cover body 72 can close the upper openings of the plurality of second setting recesses 52 on the side opposite to the bottoms.

With the second terminals 10B set in the second setting recesses 52, the cover component 70 is overlaid on the inner component 50. In this state, the bottom surface of the cover body 72 is in contact with the upper ends of the intermediate wall 56 and the pair of outer walls 60 of the inner component 50, whereby a minimum distance of the cover body 72 with respect to the inner component 50 in the vertical direction is restricted.

As described later, the cover body 72 is held in a state pressed against the inner component 50 by uniting the cover component 70 with the base component 30. Thus, the lower surface of the cover body 72 is in contact with the upper surfaces of the second terminals 10B to restrict upward movements of the second terminals 10B. In this embodiment, the position of the second terminal 10B in the vertical direction is restricted by the terminal connecting portion 13B of the second terminal 10B being sandwiched between the bottom surface of the second setting recess 52 and the downward facing surface of the cover body 72. Here, elongated protrusions are formed in parts of the cover body 72 corresponding to forward regions of the second setting recesses 52, and are arranged in the second setting recesses 52 to restrict upward movements of the second terminals 10B. Since upward movements of the second terminals 10B are restricted, the second retainers 53 are held in a state fit in the recesses of the second terminals 10B and, hence, movements of the second terminals 10B in the front-rear direction are restricted. Further, the second terminal 10B is located between both side surfaces of the second setting recess 52 and the position thereof in the lateral direction is restricted. Thus, the second terminals 10B are held at the fixed positions in the second setting recesses 52 by holding the cover component 70 in the state pressed against the inner component 50.

The pair of locking walls 74 are shaped to include a rectangular plate-like part, and extend from both side parts of the cover body 72 toward the both sides of the base component 30 through both outer sides of the inner component 50. The pair of locking walls 74 are locked to the both sides of the base component 30. In this way, the cover component 70 can be united in contact with the base component 30.

The bottom plate portion 34 of the base component 30 is located at the bottom of the connector 20, the cover body 72 is located on the top of the connector 20, and the pair of locking walls 74 are located on both sides of the connector 20. Thus, the base component 30 and the cover component 70 surround the inner component 50. In this embodiment, the base component 30 and the cover component 70 surround the inner component 50 such that the inner component 50 is not exposed on upper, lower, left and right surfaces surrounding the terminals 10A, 10B.

### Engaging Structure for Uniting

A structure for uniting the cover component 70 with the base component 30 is described.

Sliding protrusions 76a, 76b and 76c are formed on the inner surfaces of the pair of locking walls 74 of the base component 30. For example, a plurality of the sliding protrusions 76a, 76b and 76c are formed at intervals along the tip edge of the inner surface of the locking wall 74. The sliding protrusions 76a, 76b and 76c are arranged in this order from front to rear.

The uniting guide grooves 38 extending along the front-rear direction are formed in the outer surfaces of the pair of outer walls 40 of the base component 30. More specifically, groove forming protrusions 46a, 46b and 46c are formed at positions separated from the bottom plate portion 34 on the outer surface of the outer wall 40. For example, a plurality of the groove forming protrusions 46a, 46b and 46c are formed at intervals along the tip edge of the outer surface of the outer wall 40. The plurality of groove forming protrusions 46a, 46b and 46c are arranged in this order from front to rear. The uniting guide groove 38 for guiding the sliding protrusions 76a, 76b and 76c along the extension direction of the terminals 10A, 10B is formed by the outer surface of the outer wall 40, downward facing surfaces of the plurality of groove forming protrusions 46a, 46b and 46c and upward facing surface of a side part of the bottom plate portion 34.

Here, the positioning recess 36g is located between the front groove forming protrusion 46a and the middle groove forming protrusion 46b in the front-rear direction. The positioning protrusion 40p is connected above the middle groove forming protrusion 46b in the front-rear direction. These configurations are not essential.

A gap, through which the front sliding protrusion 76a can pass in the vertical direction, is provided between the front groove forming protrusion 46a and the middle groove forming protrusion 46b in the front-rear direction. A gap, through which the middle sliding protrusion 76b in the front-rear direction can pass in the vertical direction, is provided between the middle groove forming protrusion 46b in the front-rear direction and the rear groove forming protrusion 46c. Further, a gap, through which the middle groove forming protrusion 46b in the front-rear direction can pass in the vertical direction, is provided between the front sliding protrusion 76a and the middle sliding protrusion 76b in the front-rear direction. Further, a gap, through which the rear groove forming protrusion 46c can pass in the vertical direction, is provided between the middle sliding protrusion 76b in the front-rear direction and the rear sliding protrusion 76c.

A position restricting surface 46af1 is formed in a part of the front groove forming protrusion 46a on the side of the bottom plate portion 34 (see FIG. 3 and 6 to 8). The position restricting surface 46af1 is parallel to the upward facing surface of the bottom plate portion 34. An interval between the position restricting surface 46af1 and the bottom plate portion 34 is set to be equal to a vertical dimension of the sliding protrusion 76a.

A guide surface 46af2 is formed behind the position restricting surface 46af1 in a part of the front groove forming protrusion 46a on the side of the bottom plate portion 34 (see FIGS. 3, 7 and 8). The guide surface 46af2 is an inclined surface extending in a direction gradually separating from the bottom plate portion 34 toward the rear. If the sliding protrusion 76a moves between the front groove forming protrusion 46a and the bottom plate portion 34 along an extension direction of the uniting guide groove 38, the guide surface 46af2 guides the sliding protrusion 76a toward the bottom plate portion 34. In this way, the cover component 70 moves in a direction approaching the base component 30 as moving forward.

An interference surface 46af3 is formed in a rearward facing part of the front groove forming protrusion 46a (see FIGS. 3, 7 and 8). The interference surface 46af3 extends in a direction intersecting, here in a direction orthogonal to, the extension direction of the uniting guide groove 38. When the cover component 70 is united with the base component 30, the sliding protrusions 76a interfere with the interference surfaces 46af3 if the inner component 50 or the cover component 70 is in a state separated and lifted from a proper assembly state with respect to the base component 30. In this way, a movement of the cover component 70 is hindered.

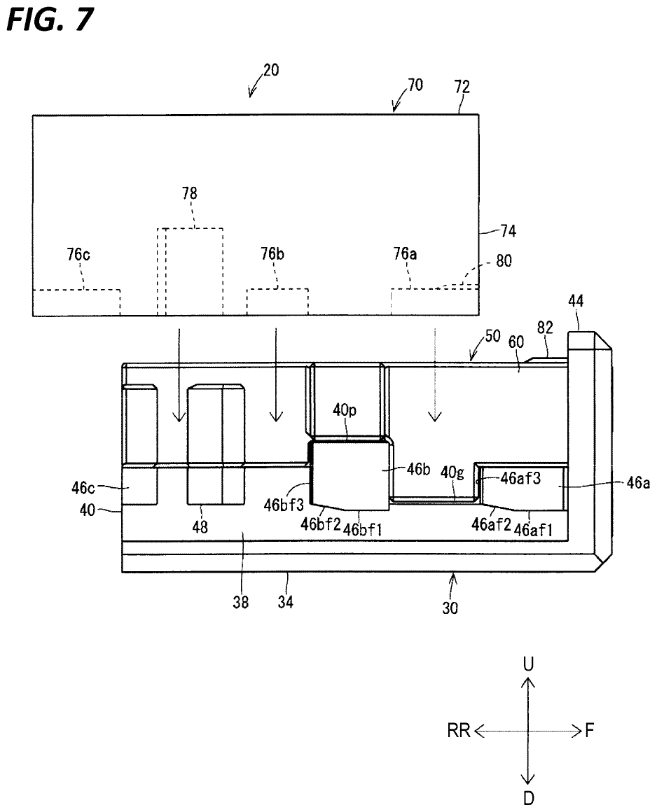

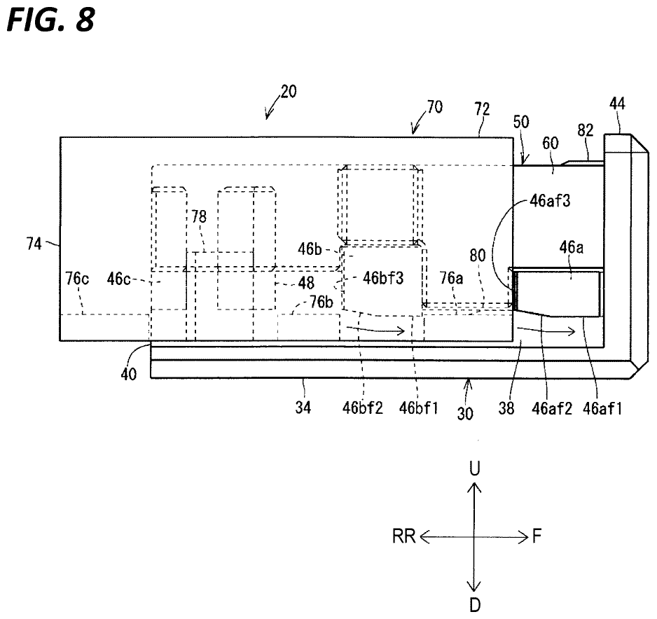

The middle groove forming protrusion 46b in the front-rear direction is also formed with a position restricting surface 46bf1, a guide surface 46bf2 and an interference surface 46bf3 corresponding to the position restricting surface 46af1, the guide surface 46af2 and the interference surface 46af3 (see FIGS. 7 and 8).

Note that the sliding protrusions 76a, 76b may be formed with guide surfaces in addition to or instead of the guide surfaces 46af2, 46bf2. In this case, the guide surfaces extending gradually downward toward the rear may be formed on upward facing parts of the sliding protrusions 76a, 76b near rear ends.

A retaining protrusion 48 is formed on the outer surface of the outer wall 40, here at a rearward position. The retaining protrusion 48 is shaped to include a part having a projecting dimension gradually reduced toward the rear. A retaining protrusion 78 is formed on the inner surface of the locking wall 74, here at a rearward position. The retaining protrusion 78 is shaped to include a part having a projecting dimension gradually reduced toward the front.

In this embodiment, the retaining protrusion 78 is located between the middle sliding protrusion 76b in the front-rear direction and the rear sliding protrusion 76c, and the retaining protrusion 48 is located between the middle groove forming protrusion 46b in the front-rear direction and the rear groove forming protrusion 46c. When the base component 30 and the cover component 70 are united, the retaining protrusions 78 can move in the vertical direction between the middle groove forming protrusions 46b in the front-rear direction and the rear groove forming protrusions 46c and behind the retaining protrusions 48.

By accommodating the sliding protrusions 76a, 76b and 76c in the uniting guide grooves 38, the cover component 70 is positioned in the vertical direction with respect to the base component 30. Particularly, the cover component 70 is positioned by the sliding protrusions 76a, 76b being located between the position restricting surfaces 46af1, 46bf1 and the upper surface of the bottom plate portion 34. Further, the retaining protrusions 48 and the retaining protrusions 78 are retained and locked with the front end of the cover component 70 held in contact with the rear surface of the front wall 44, whereby the cover component 70 is positioned in the front-rear direction with respect to the base component 30.

In this embodiment, the outer walls 60 of the inner component 50 are formed with protrusions shaped by extending the groove forming protrusions 46b, 46c and the retaining protrusions 48 upward. These protrusions on the inner component 50 may be omitted.

Note that it is not essential that the plurality of sliding protrusions and the plurality of groove forming protrusions are provided at intervals in the front-rear direction. Continuous sliding protrusions and continuous groove forming protrusions may be formed. In this case, the sliding protrusions may be arranged in uniting guide grooves from behind a base component.

### Crush Ribs

The base component 30, the inner component 50 or the cover component 70 may include crush ribs 80, 82 projecting in the uniting direction of the base component 30, the inner component 50 and the cover component 70 and crushable in a united state of those components. The uniting direction is a stacking direction of the base component 30, the inner component 50 and the cover component 70 to be assembled and, in this embodiment, the vertical direction. In FIG. 6, the shapes of the crush ribs 80, 82 before being crushed are shown by broken lines.

That is, the cover component 70 is united with the base component 30 with the inner component 50 sandwiched between the base component 30 and the cover component 70. An inner component arrangement space for the inner component 50 between the cover component 70 and the base component 30 may be possibly larger or smaller than the actual inner component 50. If the inner component arrangement space is larger than the actual inner component 50, the inner component 50 possibly rattles. If the inner component arrangement space is smaller than the actual inner component 50, it may not be possible to unite the cover component 70 with the base component 30 well.

Since the base component 30, the inner component 50 or the cover component 70 includes the crush ribs 80, 82, the crush ribs 80, 82 can fill up gaps between the respective components 30, 50 and 70 to suppress rattling. Further, if the inner component arrangement space is smaller than the actual inner component 50, the crush ribs 80, 82 can be crushed and the cover component 70 can be united with the base component 30.

In this embodiment, the cover component 70 includes first crush ribs 80 located in contact parts of the base component 30 and the cover component 70. More specifically, the first crush ribs 80 projecting upward are formed on the upward facing surfaces of the front sliding protrusions 76a of the cover component 70.

The first crush rib 80 is formed into a protrusion shape elongated along the front-rear direction. Further, the first crush rib 80 is shaped to become gradually narrower from a base end side toward a tip side. Here, the first crush rib 80 is formed into a triangular shape when viewed along the front-rear direction. Thus, if the groove forming protrusion 46a of the base component 30 is pressed against the first crush rib 80, the first crush rib 80 can be successively crushed from the tip side.

Further, a rear end part of the first crush rib 80 is shaped to have a height gradually reduced toward the rear.

The first crush ribs 80 may be formed in other parts of the cover component 70. For example, the first crush ribs 80 may be formed on the tips of the other groove forming protrusions 46b, 46c, the pair of locking walls 74 or the like. If the first crush ribs 80 are formed at positions closer to the front end edge on the side of the front wall 44 than to the rear end edge distant from the front wall 44, the rattling of the base component 30 and the cover component 70 can be eliminated near the front wall 44. Further, the terminals 10A, 10B are easily arranged at the fixed positions with respect to the front wall 44 near the front wall 44.

The first crush ribs 80 may be formed on the base component 30. For example, the first crush ribs 80 may be formed on surfaces of the groove forming protrusions 46a, 46b and 46c on the side of the bottom plate portion 34, out of the base component 30.

Further, the inner component 50 includes the second crush ribs 82 located in contact parts of the inner component 50 and the cover component 70. More specifically, the second crush ribs 82 projecting upward are formed at forward positions near tip parts of the pair of outer walls 60, out of the inner component 50. The second crush rib 82 is formed into a protrusion shape elongated along the front-rear direction. A rear end part of the second crush rib 82 is shaped to have a projecting dimension gradually reduced toward the rear.

Similarly to the first crush rib 80, the second crush rib 82 is shaped to become gradually narrower from a base end side toward a tip side. Here, the second crush rib 82 is formed into a triangular shape when viewed along the front-rear direction. Thus, if the cover body 72 of the cover component 70 is pressed against the second crush rib 82, the second crush rib 82 can be successively crushed from the tip side.

The second crush ribs 82 may be formed in other parts of the inner component 50. For example, the second crush ribs 82 may be formed at positions near the rear ends of the pair of outer walls 40 and may be formed on the intermediate wall 56. If the second crush ribs 82 are formed at positions closer to the front wall 44 than a center in the front-rear direction, i.e. closer to the front end edge on the side of the front wall 44 than to the rear end edge distant from the front wall 44, the rattling of the inner component 50 and the cover component 70 can be eliminated near the front wall 44. Further, the terminals 10A, 10B are easily arranged at the fixed positions with respect to the front wall 44 near the front wall 44.

The second crush ribs 82 may be formed on the cover component 70. For example, the second crush ribs 82 may be formed at positions facing the outer walls 60 on the downward facing surface of the cover body 72.

The base component 30 and the inner component 50 are preferably in contact without via any crush rib. That is, parts having a given shape are preferably held in contact with each other between the base component 30 and the inner component 50. In this embodiment, the upper ends of the outer walls 40 and the upper end of the intermediate wall 36 are in contact with the downward facing surface of the bottom plate portion 54 while keeping a stable shape. Thus, as compared to the case where crush ribs are interposed between the base component 30 and the inner component 50 with the inner component 50 pressed against the base component 30, a positional relationship of the inner component 50 with the base component 30 is kept constant.

That is, the cover component 70 is positioned to suppress rattling via the crush ribs 80, 82 with respect to both the base component 30 and the inner component 50 held in the constant positional relationship.

### Concerning Assembly Operation Example

An assembly operation example of the connector 20 is described.

The first terminal 10A is set in each of the first setting recesses 32 of the base component 30. The inner component 50 is overlaid on the base component 30 from above. At this time, the positioning protrusions 40p are fit into the positioning recess 60g, and the positioning protrusions 56p, 60p are fit into the positioning recesses 36g. In this way, the inner component 50 is positioned in the front-rear direction with respect to the base component 30.

The second terminal 10B is set in each of the second setting recesses 52 of the inner component 50. Thereafter, as shown in FIG. 7, the cover component 70 is overlaid on the inner component 50 from above. More specifically, the pair of locking walls 74 are arranged outside the both sides of the inner component 50 with the cover component 70 arranged at a position shifted rearward of the base component 30 and the inner component 50. At this time, the front sliding protrusions 76a pass between the front groove forming protrusions 46a and the middle groove forming protrusions 46b in the front-rear direction, the middle sliding protrusions 76b in the front-rear direction and the retaining protrusions 78 pass between the middle groove forming protrusions 46b in the front-rear direction and the rear groove forming protrusions 46c, and the rear sliding protrusions 76c pass behind the rear groove forming protrusions 46c. In this way, the pair of locking walls 74 are arranged on the pair of outer walls 40 of the base component 30 through the both outer sides of the inner component 50.

As shown in FIG. 8, with the sliding protrusions 76a, 76b and 76 located in the uniting guide grooves 38 beyond the groove forming protrusions 46a, 46b and 46c, the cover component 70 is pushed forward with respect to the base component 30 and the inner component 50.

At this time, if the inner component 50 is lifted up with respect to the base component 30 or the cover component 70 is lifted up with respect to the inner component 50, the sliding protrusions 76a, 76b interfere with the interference surfaces 46af3, 46bf3. Thus, when the cover component 70 cannot be moved forward, the lift of the inner component 50 or the lift of the cover component 70 can be detected.

When the sliding protrusions 76a, 76b and 76c move in the uniting guide grooves 38, the sliding protrusions 76a, 76b can move by being pressed toward the bottom plate portion 34 by the guide surfaces 46af2, 46bf2 and enter between the position restricting surfaces 46af1, 46bf1 and the bottom plate portion 34. Thus, the rattling of the cover component 70 with respect to the base component 30 is suppressed.

If the cover component 70 moves forward until a front end part of the cover component 70 contacts the inner surface of the front wall 44, the retaining protrusions 78 are retained and locked to the retaining protrusions 48.

In the above way, the connector 20 is assembled.

### Effects, Etc.

According to the connector 20 configured as described above, the cover component 70 is united in contact with the base component 30 with the inner component 50 sandwiched between the base component 30 and the cover component 70. Thus, the first terminals 10A in the first setting recesses 32 are positioned between the base component 30 and the inner component 50 positioned on the basis of the base component 30. Further, the second terminals 10B in the second setting recesses 52 are positioned between the inner component 50 positioned on the basis of the base component 30 and the cover component 70. Thus, the accumulation of dimensional tolerances of the plurality of components 30, 50 and 70 hardly affects a relative positional relationship of the first and second terminals 10A, 10B. Therefore, relative position deviations between the different terminals 10A, 10B can be reduced.

For example, assuming a configuration in which a base component and a cover component are separately mounted on the basis of an inner component, a relative positional relationship of the base component and the cover component possibly varies within an accumulation range of dimensional tolerances of three components. Thus, a relative positional relationship of terminals positioned between the inner component and the base component and terminals positioned between the inner component and the cover component is thought to largely deviate. If the relative positional relationship of the terminals in respective stages easily deviates, the terminals in the respective stages cannot be precisely held with respect to arrayed mating terminals and it may possibly become difficult to simultaneously insert the mating terminals into the terminals in the respective stages.

In this embodiment, the inner component 50 and the cover component 70 can be positioned on the basis of the base component 30, and relative position deviations of the terminals 10A, 10B held between those components can be reduced. Thus, the mating terminals can be easily inserted into the terminals 10A, 10B in the respective stages.

Further, since the base component 30 and the cover component 70 surround the inner component 50, errors of the outer shape of the connector 20 can be reduced as compared to the case where the outer shape of the connector 20 is defined by a combination of three or more components.

Further, the base component 30 includes the front wall 44 having the insertion guide holes 44h, and the first and second terminals 10A, 10B are positioned via the inner component 50 and the cover component 70 on the basis of the base component 30. Thus, the mating terminals guided by the insertion guide holes 44h are smoothly inserted into the first and second terminals 10A, 10B.

Further, the base component 30, the inner component 50 or the cover component 70 includes the crush ribs 80, 82 projecting in the uniting direction of those components and crushable in the united state of those components. Thus, rattling between the respective components 30, 50 and 70 can be suppressed.

Further, the base component 30 or the cover component 70 includes the first crush ribs 80 located in the contact parts of the base component 30 and the cover component 70, and the inner component 50 or the cover component 70 includes the second crush ribs 82 located in the contact parts of the inner component 50 and the cover component 70. Thus, by the crushing of the crush ribs 80, 82, rattling between the base component 30 and the cover component 70 and rattling between the inner component 50 and the cover component 70 can be suppressed. As a result, the rattling of the entire connector 20 can be suppressed. Further, since crush ribs need not be interposed between the base component 30 and the inner component 50, relative position errors of the base component 30 and the inner component 50 can be reduced. As a result, position errors of the first terminals 10A in the first setting recesses 32 of the base component 30 and the second terminals 10B in the second setting recesses 52 of the inner component 50 can be reduced.

Further, if being shaped to become gradually narrower from the base end side toward the tip side, the crush ribs 80, 82 can be gradually crushed from the tips according to the sizes of the gaps between the respective components 30, 50 and 70.

Further, if the crush ribs 80, 82 are located near the front wall 44, the rattling of each component 30, 50, 70 can be suppressed near the insertion guide holes 44h. In this way, the terminals 10A, 10B are more accurately positioned near the insertion guide holes 44h and the mating terminals are easily smoothly connected.

Further, the cover component 70 includes the pair of locking walls 74 extending from the both sides of the cover body 72 toward the both sides of the base component 30 through the both outer sides of the inner component 50 and to be locked to the both sides of the base component 30. Thus, a configuration for uniting the cover component 70 with the base component 30 with the inner component 50 sandwiched between the base component 30 and the cover component 70 can be easily realized.

Further, the pair of locking walls 74 are formed with the sliding protrusions 76a, 76b and 76c, and the uniting guide grooves 38 are formed in the both sides of the base component 30. Thus, by moving the sliding protrusions 76a, 76b and 76c along the uniting guide grooves 38 with the inner component 50 overlaid on the base component 30, the cover component 70 is united with the base component 30 and the connector 20 is assembled.

Since the base component 30 is formed with the interference surfaces 46af3, 46bf3, the base component 30 cannot be moved if the inner component 50 or the cover component 70 is lifted. Thus, an assembly failure due to the lift of the inner component 50 or the cover component 70 is suppressed. Particularly, since it is difficult to observe the inner component 50 from outside, it is effective that the lift of the inner component 50 can be detected based on whether or not the cover component 70 located outside can be moved.

Further, since the base component 30 or the uniting guide grooves 38 is/are formed with the guide surfaces, if the sliding protrusions 76a, 76b are moved along the uniting guide grooves 38, the cover component 70 approaches the base component 30 and rattling between the cover component 70 and the base component 30 is suppressed.

Further, the first retainers 33 are formed on the bottoms of the first setting recesses 32, and the second retainers 53 are formed on the bottoms of the second setting recesses 52. Thus, the first and second terminals 10A, 10B can be retained from the outside of the first and second setting recesses 32, 52. In this way, the postures of the first terminals 10A in the first setting recesses 32 and those of the second terminals 10B in the second setting recesses 52 are easily aligned.

Note that the respective configurations described in the above embodiment and modifications can be appropriately combined without contradicting each other.

### LIST OF REFERENCE NUMERALS

10A first terminal
10B second terminal
11A, 11B coating crimping portion
12A, 12B core wire crimping portion
13A, 13B terminal connecting portion
18 wire
20 connector
30 base component
32 first setting recess
33 first retainer
34, 54 bottom plate portion
36, 56 intermediate wall
36g positioning recess
38 uniting guide groove
40,60 outer wall
40g, 60g positioning recess
40p, 56p, 60p positioning protrusion
44 front wall
44h insertion guide hole
46a, 46b, 46c groove forming protrusion
46af1, 46bf1 position restricting surface
46af2, 46bf2 guide surface
46af3, 46bf3 interference surface
48, 78 retaining protrusion
50 inner component
52 second setting recess
53 second retainer
70 cover component
72 cover body
74 locking wall
76a, 76b, 76c sliding protrusion
80 first crush rib (crush rib)
82 second crush rib (crush rib)

1. A connector for holding a first terminal and a second terminal, comprising:
a base component including a first setting recess, the first terminal being set in the first setting recess;
an inner component to be overlaid on the base component to close an opening on a side opposite to a bottom of the first setting recess, the inner component including a second setting recess, the second terminal being set in the second setting recess; and
a cover component to be overlaid on the inner component to close an opening on a side opposite to a bottom of the second setting recess, the cover component being united in contact with the base component with the inner component sandwiched between the base component and the cover component.

2. The connector of claim 1, wherein the base component and the cover component surround the inner component.

3. The connector of claim 1, wherein the base component includes a front wall having insertion guide holes for guiding mating terminals to be connected to the first terminal and the second terminal.

4. The connector of claim 1, wherein the base component, the inner component or the cover component includes a crush rib projecting in a uniting direction of the base component, the inner component or the cover component, the crush rib being crushable in a united state of the base component, the inner component and the cover component.

5. The connector of claim 4, wherein:
the base component or the cover component includes a first crush rib located in a contact part of the base component and the cover component as the crush rib, and
the inner component or the cover component includes a second crush rib located in a contact part of the inner component and the cover component as the crush rib.

6. The connector of claim 4, wherein the crush rib is shaped to become gradually narrower from a base end side toward a tip side.

7. The connector of claim 4, wherein:
the base component, the inner component or the cover component includes a front wall having insertion guide holes for guiding mating terminals to be connected to the first terminal and the second terminal, and
the crush rib is located closer to an edge on side of the front wall than to an edge distant from the front wall in the base component, the inner component or the cover component.

8. The connector of claim 1, wherein the cover component includes a cover body for closing the opening on the side opposite to the bottom of the second setting recess and a pair of locking walls extending from both sides of the cover body toward both sides of the base component through both outer sides of the inner component and to be locked to the both sides of the base component.

9. The connector of claim 8, wherein:
sliding protrusions are formed on inner surfaces of the pair of locking walls, and
uniting guide grooves for guiding the sliding protrusions along an extension direction of the first terminal are formed on the both sides of the base component.

10. The connector of claim 9, wherein the base component is formed with an interference surface extending in a direction intersecting an extension direction of the uniting guide groove, the interference surface interfering with the sliding protrusion moving with the inner component or the cover component lifted with respect to the base component.

11. The connector of claim 9, wherein the base component or the uniting guide groove has a guide surface for guiding the cover component in a direction to be brought closer to the base component as the sliding protrusion moves along the extension direction of the uniting guide groove.

12. The connector of claim 1, wherein:
a first retainer for retaining the first terminal is formed on the bottom of the first setting recess, and
a second retainer for retaining the second terminal is formed on the bottom of the second setting recess.
